(19) United States
(12) Patent Application Publication
(10) Pub. No.: US 2013/0256300 A1
(43) Pub. Date: Oct. 3, 2013

(54) PORTABLE DEVICE FOR INDUCTION COOKING

(71) Applicant: Peter Alwin, Stockholm (SE)

(72) Inventor: Peter Alwin, Stockholm (SE)

(73) Assignee: AKTIEBOLAGET ELECTROLUX, Stockholm (SE)

(21) Appl. No.: 13/696,914

(22) PCT Filed: May 13, 2011
(86) PCT No.: PCT/EP11/57787

§ 371 Date: May 13, 2013

(30) Foreign Application Priority Data
May 14, 2010 (SE) 1000509-8

(51) Int. Cl. H05B 6/12

(52) U.S. Cl. CPC H05B 6/1209
USPC 219/620

(57) ABSTRACT

The present invention relates to a portable device (1) for induction cooking. The portable device comprises an element (160) configured to provide electromagnetic induction for heating of a cooking utensil (200), and a base (110) attachable to the cooking utensil. The portable device according to the present invention is advantageous in that it is easier to move and has a reduced size as compared to prior art techniques.

### FIELD OF THE INVENTION

The present invention generally relates to the field of portable devices for induction cooking.

### BACKGROUND OF THE INVENTION

In induction cooking stoves, induction is used to generate heat for cooking objects. Typically, a cooking utensil made of an electrically conducting magnetic material is placed over a copper coil comprised in a stove plate of the induction cooking stove. An alternating electric current flows in the copper coil, whereby an oscillating magnetic field is induced. The oscillating magnetic field generates currents in the cooking utensil (commonly referred to as eddy currents or Foucault currents). As a result, the cooking utensil gets hot (because of resistive heating), which in turn heats the cooking object.

Portable stove plates for induction cooking are known in the art. Such portable stove plates are designed to be more space saving and easier to move compared to traditional stoves. An example of a portable food heating device using induction heating is disclosed in U.S. Pat. No. 6,279,471. The portable food heating device comprises a tray having a plate zone at which a plate is intended to be placed. The tray comprises an inducer for heating the plate zone by induction. A drawback with such a portable food heating device is that it is still relatively space taking and cumbersome to move, whereby the mobility of the device is reduced. In addition, the plate zone in the tray will remain hot after removing the heated food, thereby increasing the risk of burn injuries when handling the portable food heating device.

### SUMMARY OF THE INVENTION

Thus, there is a need for providing alternatives and/or new devices that would overcome, or at least alleviate or mitigate, at least some of the above mentioned drawbacks. It is with respect to the above considerations that the present invention has been made. An object of the present invention is to provide an improved alternative to the above mentioned technique and prior art. More specifically, it is an object of the present invention to improve the mobility of a portable device for induction cooking.

These and other objects of the present invention are achieved by means of a portable device having the features defined in the independent claim. Preferable embodiments of the invention are characterized by the dependent claims.

Hence, according to a first aspect of the present invention, a portable device for induction cooking is provided. The portable device comprises an element configured to provide electromagnetic induction for heating of a cooking utensil, and a base attachable to the cooking utensil.

The present invention is based on the idea of bringing the device for induction cooking to the cooking utensil instead of bringing the cooking utensil to the device for induction cooking. To achieve that, the portable device is provided with a base attachable to the cooking utensil, whereby the cooking utensil does not need to be located on a stove and thereby does not need to be at a specific position during cooking.

The present invention is advantageous in that the mobility of the portable device is improved, which allows the cooking to take place for instance on a dining table, a worktop, a work place, out-door or at any other places not primarily intended for cooking. The portable device according to the present invention is easier to move and enables a more space saving design as compared to prior art techniques. When cooking is completed, the portable device is easily removed from the cooking utensil and can e.g. be stowed away or moved to another cooking utensil.

Further, the present invention is advantageous in that the need of moving the cooking utensil before, during and after the cooking is reduced since cooking with the cooking utensil can be performed where the cooking object (e.g. food) is intended to be served. Thus, heavy lifts of (hot) cooking utensils with heavy contents can be limited. Further, the risk of burn injuries is reduced because of the reduced need of moving hot cooking utensils.

The present invention is also advantageous in that heating of the portable device itself is greatly reduced since the induction heating produces heat directly in the cooking utensil (instead of producing heat in the portable device). Hence, the portable device can be handled with a reduced risk of getting burned, which makes it easier to handle.

According to an embodiment of the present invention, the base may be made of a flexible material, preferably a heat resistive rubber. The present embodiment is advantageous in that the surface contact between the portable device and the cooking utensil is improved since the base can adapt to the form of the cooking utensil. A flexible base can adapt to a wide range of sizes and shapes of cooking utensils. Further, an improved surface contact for a close fit of the base to the cooking utensil increases the efficiency of the induction heating, in particular if the element (or elements) is provided in the base. In such an arrangement, the element then comes closer to the cooking utensil. Further, in yet another embodiment, the element may also be flexible and arranged at the base, such that the element can also adapt to the form of the cooking utensil, thereby further increasing the efficiency of the induction heating since the element is arranged more closely to the cooking utensil.

In an embodiment of the present invention, the element may be formed as at least one strip of conducting material, which is advantageous in that the element is more flexible and the size of the element is reduced. Further, the element may be a coil, preferably of copper (such as copper wire), which is advantageous in that it makes the induction heat production more effective. The coil shape provides an effective alternative for creating the magnetic field required to induce currents in the cooking utensil (thereby generating heat) and the copper provides an improved conduction of electricity in the coil.

In an embodiment of the present invention, the portable device may comprise a plurality of elements configured to provide electromagnetic induction for heating of the cooking utensil. The plurality of elements may preferably be uniformly spread over the area of the base of the portable device. The present embodiment is advantageous in that each element may have a reduced size, still providing sufficient electromagnetic induction. In addition, the plurality of elements (instead of a single element of larger size) contributes to make the base more flexible and facilitates fitting to the cooking utensil, since the portions of the base between the elements can be made more flexible than the portions of the base at which the elements are arranged, particularly if the elements are stiffer than the material of the base.

According to an embodiment of the present invention, the base of the portable device may be adapted to be attached to a cooking utensil made of metal, preferably ferromagnetic metal, which are materials enabling the induction of currents in the cooking utensil. For this purpose, the portable device may be provided with attachment means for attaching the portable device to ferromagnetic material.

In embodiments of the invention, the portable device may further comprise attachment means adapted to attach the base at a surface of the cooking utensil, such that the portable device is more firmly attached to the cooking utensil. For example, the base may be provided with a suction cup for attachment to the cooking utensil. The suction cup may be made in a flexible material, which is advantageous in that it also better adapts to the shape of the cooking utensil. The base may itself be formed as a suction cup or alternatively provided with a plurality of suction cups, whereby the cooking utensil becomes more firmly attached.

In embodiments of the invention, the base may be provided with a magnet for attachment to the cooking utensil, which is advantageous in that it is a suitable manner for attaching an object (the portable device) to a cooking utensil made of magnetic material. A magnet provides a suitable adhering force. As a result, the portable device is firmly secured to the cooking utensil, yet easy to remove.

Preferably, the base may be provided with a plurality of magnets for attachment to the cooking utensil, wherein the magnets may be uniformly spread at the base, which is advantageous in that the base is more firmly secured to the cooking utensil. Further, using plurality of magnets (instead of only one magnet of a larger size) contributes to make the base more flexible and easy to fit to the cooking utensil, since the portions of the base between the magnets can be made more flexible than the portions of the base at which the magnets are arranged, if the magnets are stiffer than the material of the base.

According to an embodiment of the invention, the base may comprise an adhesive surface for attachment to the cooking utensil, which is an alternative manner facilitating the attachment of the portable device to various surfaces of cooking utensils since the adhesive surface is less dependent on surface characteristics such as surface roughness.

In embodiments of the invention, the portable device may further comprise a body attached to the base, wherein the body is preferably shaped for manually holding the portable device, thereby facilitating the handling of the portable device. For example, the body may comprise a handle, further facilitating the manipulation of the portable device, in particular for applying and removing the portable device to and from the cooking utensil.

According to embodiments of the invention, the portable device may further comprise a user interface for displaying of, and/or allowing input of, cooking parameters, thereby enabling monitoring and control of the cooking process. Further, the portable device may comprise a temperature sensor for sensing the temperature of the cooking utensil and/or a cooking object located in the cooking utensil. The portable device may then be configured to determine cooking parameters for the cooking object based on data from the temperature sensor, thereby facilitating monitoring and control of the cooking operation. Moreover, the portable device may comprise a sensor for detecting the amount and/or the type of the cooking object, thereby further improving the cooking of the cooking object and the cooking result.

In an embodiment of the present invention, the portable device may further comprise a power unit for activating the element. The present embodiment is advantageous in that the portable device can be self powered, thereby further improving mobility. With its own power unit, the portable device does not need to be connected via a cable to a socket (or main supply network).

Further objectives of, features of, and advantages with, the present invention will become apparent when studying the following detailed disclosure, the drawings and the appended claims. Those skilled in the art realize that different features of the present invention can be combined to create embodiments other than those described in the following.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, in which:

FIG. 1 shows a portable device according to an embodiment of the present invention;

FIG. 2 shows a bottom view of a portable cooking device according to an embodiment of the present invention;

FIG. 3 shows an exploded view of a portable device according to an embodiment of the present invention; and

FIG. 4 shows a portable device applied to a cooking utensil according to an embodiment of the present invention.

All the figures are schematic, not necessarily to scale, and generally only show parts which are necessary in order to elucidate the invention, wherein other parts may be omitted or merely suggested.

### DETAILED DESCRIPTION OF EMBODIMENTS

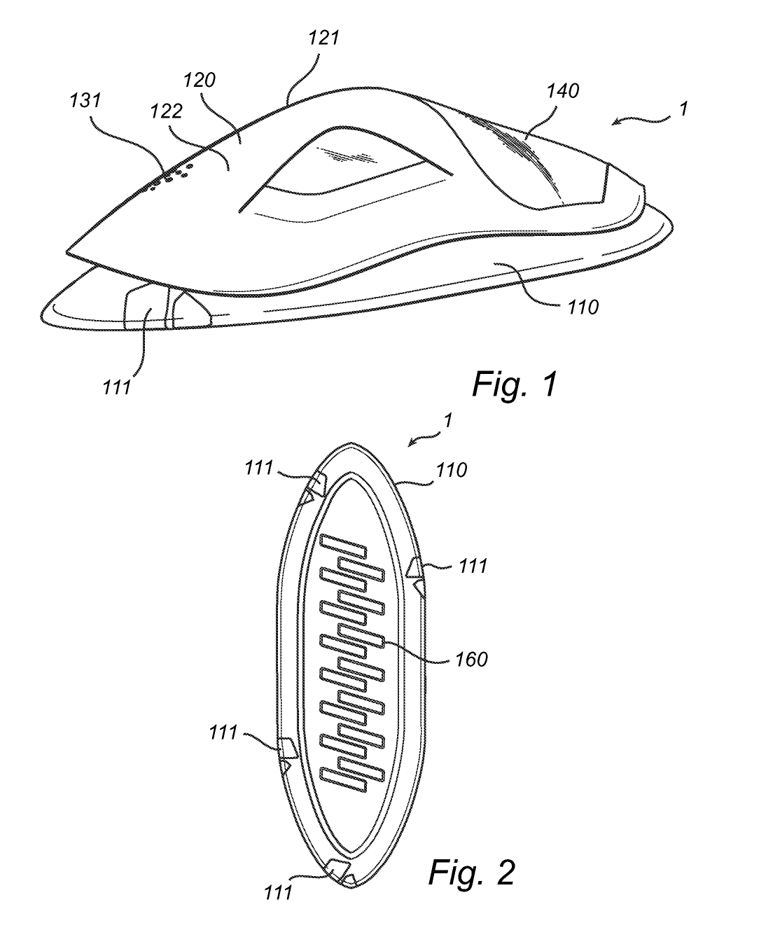

With reference to FIG. 1, there is shown a portable device 1 for induction cooking according to an embodiment of the present invention. The portable device 1 comprises a body 120 including a handle 121 for holding and manipulating the portable device 1. The portable device 1 further comprises a power unit 130, such as a battery pack or a high density sugar crystal wafer sheet layered battery which utilizes energy from sugar. A by-product from such a high density sugar crystal wafer sheet layered battery is water, which may be evaporated through outlet ducts (or holes) 131 provided in the body 120. The power unit 130 may preferably be rechargeable and/or replaceable. For example, the portable device 1 may be adapted to be docked to a charging unit connected to the mains to be recharged. It will be appreciated that the portable device 1 may alternatively be powered (or activated) directly by the mains via a cable connected to a socket.

The portable device 1 further comprises a user interface 140, such as a display and preferably a touch sensitive display allowing monitoring of the cooking process and entry of cooking parameters, such as cooking time and temperature. Alternatively, the user interface may be provided with entry means, such as knobs and buttons for allowing input of cooking parameters.

The body 120 may further include a cover (or shell) 122 made of plastics, in which the handle 121, as well as the user interface 140, preferably are integrated. Further, the power unit 130 may be arranged under the cover 122.

The portable device 1 further comprises a base 110 attached to the body 120. The base 110 is preferably made of a flexible material having elastic and heat resistive properties, such as a natural or synthetic rubber. Preferably, the base 110 is made of silicone, which is highly flexible and can withstand temperatures up to about 260° C. Further, silicone (and other synthetic rubbers) is advantageous in that it provides heat insulation between the cooking utensil and the components comprised in the body 120. The base 110 may further comprise magnets 111 for attaching the portable device 1 to a cooking utensil.

The base 110 will now be described in more detail with reference to FIG. 2. FIG. 2 shows the underside of the portable device 1 comprising the base 110, i.e. a view of the bottom side of the portable device 1. The base is attachable to a cooking utensil. As shown in FIG. 2, the magnets 111 are uniformly spread at the base 110, preferably circumferentially at (or near) the edge of the base 110. Further, the magnets 110 may be entirely or partly encapsulated in the base 110. The base 110 may be provided with a number of magnets (e.g. four as shown in FIG. 2) sufficient for providing a suitable adhering force between the portable device 1 and the cooking utensil.

Alternatively, or as a complement, the base 110 may comprise other attachment means, such as one or more suction cups and/or an adhesive surface for attaching the portable device 1 to the cooking utensil. It will be appreciated that the base itself may be formed as a suction cup or that the base may be provided with separate attaching elements being suction cups.

The portable device 1 may further comprise elements 160 electrically connected to the power unit and configured to provide electromagnetic induction. The elements 160 may preferably be arranged at the base 110, e.g. embedded in the silicone, close to the attachment surface of the base 110, such that they can be close to the cooking utensil, thereby improving heat efficiency. Alternatively, the elements 160 may be provided in the body of the portable device. Moreover, the elements 160 may be uniformly spread to improve the heating uniformity, in particular for a large area of the base 110. For example, the elements 160 may be flexible strips of conducting material (such as metal), as shown in FIG. 2, which generates a magnetic field when conducting a current provided by the power unit 130 or an external power source. Preferably, the elements 160 (or strips) may be coils of copper wire.

The portable device 1 may further comprise a temperature sensor (not shown) for detecting the temperature of the cooking utensil and/or the cooking object. The temperature sensor may for example be arranged in the base 110 and adapted to sense the temperature of the cooking utensil. The portable device 1 may also comprise other sensors, such as a humidity sensor, an optical sensor and/or an infrared sensor for detecting the amount and/or type of cooking object. Data from the sensors may be displayed on the display 140 and used to determine cooking parameters such as time and temperature. Optionally, data from the sensors may be saved in a memory unit (not shown), which may be provided in the portable device 1, for future use, e.g. if the same type and amount of cooking object is to be cooked again. Further, the memory unit may store different predetermined cooking programs with predetermined cooking parameters. A user may then select a cooking program, whereby the predefined cooking parameters are automatically set.

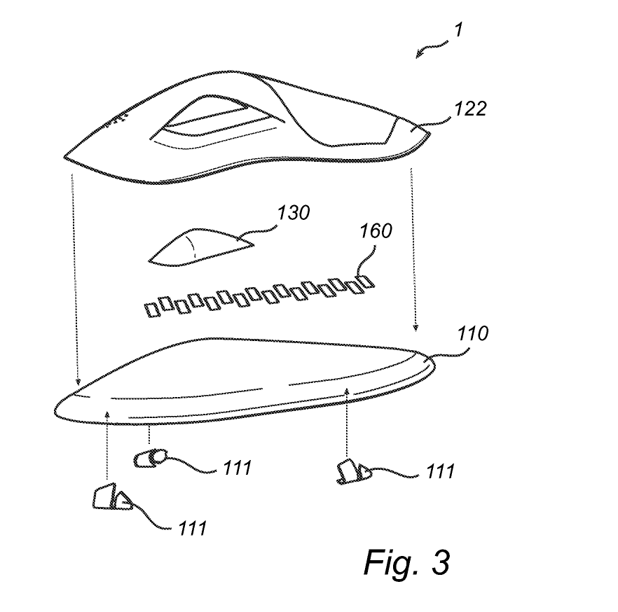

FIG. 3 shows an exploded view of the portable device 1 according to an embodiment of the present invention. FIG. 3 shows the base 110, the magnets 111, the element 160 formed as conducting strips, the power unit 130 and the cover 122 of the body. The cover 122 and the base 110 may preferably be arranged to encapsulate (enclose) the other components of the portable device 1, such as the element 160, and the power unit 130 and optionally the magnets 111.

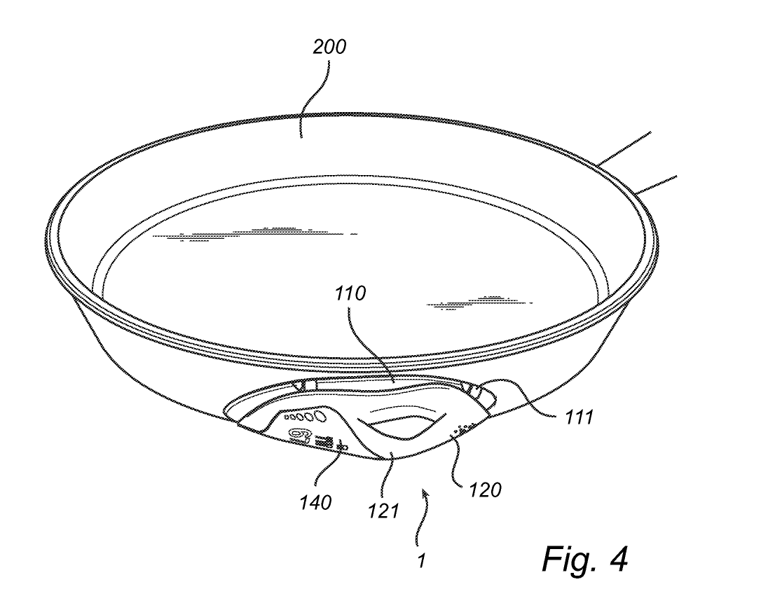

With reference to FIG. 4, the operation of the portable device 1 will be described. When the portable device 1 is to be operated, it is attached to a cooking utensil 200 as shown in FIG. 4. The portable device 1 may preferably be attached to the side, such as the outside, or optionally on the inside of the cooking utensil 200 if it is not fully loaded with the cooking object. The flexible base 110 of the portable device 1 adapts to the shape of the surface of the cooking utensil 200 to which it is applied, and the magnets 111 at the base 110 attracts the ferromagnetic material of the cooking utensil 200, thereby attaching the portable device 1 to the cooking utensil 200.

The cooking utensil 200 may for instance be a frying pan (as shown in FIG. 2), a saucepan, a kettle, a plate, or even a cup or jug, or any utensil, vessel or container made of an electrically conductive and magnetic material and adapted to contain a cooking object. Preferably, the cooking utensil 200 is made of a ferromagnetic material, such as ferromagnetic steel. The cooking utensil 200 contains the object to be cooked or heated (not shown), which for instance may be food, water, tea, coffee or any kind of load to be heated or cooked.

When the portable device 1 is attached to the cooking utensil 200 and cooking parameters are set (either manually via the user interface 140 or automatically e.g. based on data from the sensors or predetermined data stored in the memory unit), the cooking process starts. The power unit activates the elements, whereby an alternating current flows in the elements, which provides an oscillating magnetic field. The oscillating magnetic field induces an electric current in the cooking utensil 200, whereby the cooking utensil 200 is heated. The heat produced in the cooking utensil 200 is transferred to the cooking object which consequently gets heated (and cooked). During cooking, the temperature and cooking time may be displayed at the user interface 140 for allowing monitoring of the cooking process. When cooking is completed, e.g. when the cooking utensil or cooking object has attained the target temperature, the elements are (manually or automatically) deactivated and the induction cooking is interrupted. The portable device 1 may then be removed from the cooking utensil 200, e.g. by grabbing the handle 121 of the body 120 and applying a sufficient pulling force.

While specific embodiments have been described, the skilled person will understand that various modifications and alterations are conceivable within the scope as defined in the appended claims.

For example, two or more portable devices may be used for cooking food in a single cooking utensil for providing an increased and more uniform heat production in the cooking utensil. Further, the size of the portable device may be adapted to the size of the cooking utensil, such that a smaller portable device is used for a smaller cooking utensil, and either a larger portable device or two or smaller portable devices are used for a larger cooking utensil.

### Itemized List of Embodiments

1. Portable induction cooking device to be stuck to a cooking utensil, comprising a base to be attached to the cooking utensil, and at least one conducting strip.
2. Portable induction cooking device according to item 1, wherein the base is made of a flexible material, preferably silicone.
3. Portable induction cooking device according to item 2, wherein the base comprises magnets for attaching the device to the cooking utensil.
4. Portable induction cooking device according to item 2 or 3, wherein the base comprises at least one flexible conducting strip, and preferably several flexible conducting strips.
5. Portable induction cooking device according to any of the items 1-4, wherein the device is stuck to a side of the cooking utensil.
6. Portable induction cooking device according to any of the items 1-5, wherein a sensor detects amount and/or type of food in the vessel.
7. Portable induction cooking device according to item 6, wherein the data from the sensor is used to adjust the time for cooking the food.
8. Portable induction cooking device according to anyone of the above items, wherein the device comprises a battery for powering the induction heating.

1. A portable device (1) for induction cooking, the portable device comprising:
an element (160) configured to provide electromagnetic induction for heating of a cooking utensil (200), and a base (110) attachable to the cooking utensil.

2. A portable device as defined in claim 1, wherein the base is made of a flexible material, preferably a heat resistive rubber.

3. A portable device as defined in claim 1, wherein the element is flexible and arranged at the base.

4. A portable device as defined in claim 1, wherein the element is formed as at least one strip of conducting material.

5. A portable device as defined in claim 1, wherein the element is a coil, preferably of copper.

6. A portable device as defined in claim 1, further comprising a plurality of elements configured to provide electromagnetic induction for heating of the cooking utensil.

7. A portable device as defined in claim 1, wherein the base is adapted to be attached to a cooking utensil made of metal, preferably ferromagnetic metal.

8. A portable device as defined in claim 1, further comprising attachment means adapted to attach the base at a surface of the cooking utensil.

9. A portable device as defined in claim 1, wherein the base is provided with a suction cup for attachment to the cooking utensil.

10. A portable device as defined in claim 1, wherein the base is provided with a magnet (111) for attachment to the cooking utensil.

11. A portable device as defined in claim 1, wherein the base is provided with a plurality of magnets for attachment to the cooking utensil, the magnets being uniformly spread at the base.

12. A portable device as defined in claim 1, wherein the base comprises an adhesive surface for attachment to the cooking utensil.

13. A portable device as defined in claim 1, further comprising a body (120) attached to the base, the body being preferably shaped for manually holding the portable device.

14. A portable device as defined in claim 13, wherein the body comprises a handle (121).

15. A portable device as defined in claim 1, further comprising a user interface (140) for displaying of, and/or allowing input of, cooking parameters.

16. A portable device as defined in claim 1, further comprising a temperature sensor for sensing the temperature of the cooking utensil and/or a cooking object located in the cooking utensil.

17. A portable device as defined in claim 16, wherein the portable device is configured to determine cooking parameters for the cooking object based on data from the temperature sensor.

18. A portable device as defined in claim 1, further comprising a sensor for detecting the amount and/or the type of the cooking object.

19. A portable device as defined in claim 1, further comprising a power unit (130) for activating the element.
